(19) United States
(12) Patent Application Publication
(10) Pub. No.: US 2009/0109206 A1
(43) Pub. Date: Apr. 30, 2009

(54) PLASMA DISPLAY APPARATUS

(76) Inventors: Seonghak Moon, Seoul (KR); Namjin Kim, Seoul (KR)

Correspondence Address: KED & ASSOCIATES, LLP, P.O. Box 221200, Chantilly, VA, 20153-1200, US

(21) Appl. No.: 12/262,611

(22) Filed: Oct. 31, 2008

(30) Foreign Application Priority Data
Oct. 31, 2007 (KR) 10-2007-0110574

(51) Int. Cl. G06F 3/038

(52) U.S. Cl. 345/212

(57) ABSTRACT

A plasma display apparatus is disclosed. The plasma display apparatus includes a plasma display panel including a scan electrode, and a driver that displays an image on the plasma display panel in a frame including a plurality of subfield groups each including a plurality of subfields. The driver controls a voltage magnitude of a reset signal, that is supplied to the scan electrode during a reset period of at least one subfield of the plurality of subfields belonging to each of the plurality of subfield groups of the frame, depending on an average power level (APL).

This application claims the benefit of Korean Patent Application No. 10-2007-0110574 filed on Oct. 31, 2007, which is hereby incorporated by reference.

### BACKGROUND

1. Field

Exemplary embodiments relate to a plasma display apparatus.

2. Description of the Related Art

A plasma display apparatus includes a plasma display panel.

The plasma display panel includes a phosphor layer inside discharge cells partitioned by barrier ribs and a plurality of electrodes.

When driving signals are applied to the electrodes of the plasma display panel, a discharge occurs inside the discharge cells. In other words, when the plasma display panel is discharged by applying the driving signals to the discharge cells, a discharge gas filled in the discharge cells generates vacuum ultraviolet rays, which thereby cause phosphors positioned between the barrier ribs to emit light, thus producing visible light. An image is displayed on the screen of the plasma display panel due to the visible light.

In one aspect, a plasma display apparatus comprises a plasma display panel including a scan electrode, and a driver that displays an image on the plasma display panel in a frame including a plurality of subfield groups each including a plurality of subfields, wherein the driver controls a voltage magnitude of a reset signal, that is supplied to the scan electrode during a reset period of at least one subfield of the plurality of subfields belonging to each of the plurality of subfield groups of the frame, depending on an average power level (APL).

In another aspect, a plasma display apparatus comprises a plasma display panel including a scan electrode, and a driver that displays an image on the plasma display panel in a frame including a plurality of subfield groups each including a plurality of subfields, wherein the driver controls the number of subfields, in which a rising signal with a gradually rising voltage is supplied to the scan electrode in each of the plurality of subfield groups of the frame, depending on an average power level (APL).

In still another aspect, a plasma display apparatus comprises a plasma display panel including a scan electrode and a sustain electrode that are positioned parallel to each other, and a driver that displays an image on the plasma display panel in a frame including a plurality of subfields, wherein the frame includes a plurality of subfield groups each including a plurality of subfields, wherein the driver supplies a reset signal to the scan electrode during a reset period of at least one subfield of the plurality of subfields of the frame, wherein the reset signal includes a rising period during which a rising signal with a gradually rising voltage is supplied, a falling period during which a falling signal with a gradually falling voltage is supplied, and a hold period between the rising period and the falling period, during which a maximum voltage of the falling signal is hold, wherein when an average power level (APL) is a first level, a length of the hold period is a first length, wherein when the APL is a second level higher than the first level, a length of the hold period is a second length different from the first length.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 illustrates a configuration of a plasma display apparatus according to an exemplary embodiment;

FIG. 2 illustrates a structure of a plasma display panel;

FIG. 3 illustrates a frame for achieving a gray level of an image in the plasma display apparatus;

FIG. 4 illustrates an example of an operation of the plasma display apparatus;

FIG. 5 illustrates a frame comprised of a plurality of subfield groups;

FIG. 6 illustrates a reason to divide a frame into a plurality of subfield groups;

FIG. 7 illustrates a method for processing video data of a frame comprised of a plurality of subfield groups;

FIG. 8 illustrates a pause period;

FIG. 9 illustrates another method for arranging a pause period;

FIG. 10 illustrates a method for arranging subfields;

FIG. 11 illustrates another method for arranging subfields;

FIG. 12 illustrates an average power level (APL);

FIG. 13 illustrates a method for controlling a voltage of a reset signal depending on an APL;

FIG. 14 illustrates another method for controlling a voltage of a reset signal depending on an APL;

FIG. 15 illustrates another method for controlling a voltage of a reset signal depending on an APL;

FIG. 16 illustrates a method for controlling the number of subfields, in which a rising signal is supplied, depending on an APL;

FIG. 17 illustrates another method for controlling the number of subfields, in which a rising signal is supplied, depending on an APL;

FIG. 18 illustrates a method for controlling a length of a hold period depending on an APL;

FIGS. 19A and 19B illustrate a method for dividing a frame into a plurality of subfield groups;

FIG. 20 illustrates a method for dividing a frame into a plurality of subfield groups; and

FIGS. 21 to 23 illustrate changes in a length of a pause period depending on an APL and a driving method of the plasma display apparatus.

### DETAILED DESCRIPTION OF EMBODIMENTS

Reference will now be made in detail embodiments of the invention examples of which are illustrated in the accompanying drawings.

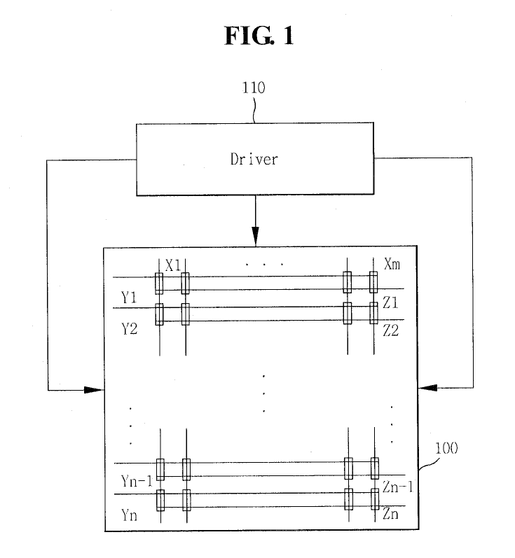

FIG. 1 illustrates a configuration of a plasma display apparatus according to an exemplary embodiment.

As shown in FIG. 1, the plasma display apparatus according to the exemplary embodiment includes a plasma display panel 100 and a driver 110.

The plasma display panel 100 includes scan electrodes Y1 to Yn and sustain electrodes Z1 to Zn positioned parallel to each other, and address electrodes X1 to Xm positioned to intersect the scan electrodes Y1 to Yn and the sustain electrodes Z1 to Zn.

The driver 110 supplies driving signals to at least one of the scan electrodes Y1 to Yn, the sustain electrodes Z1 to Zn, or the address electrodes X1 to Xm to thereby display an image on the screen of the plasma display panel 100. More specifically, the driver 100 can control a voltage magnitude of a reset signal, that is supplied to the scan electrodes Y1 to Yn during a reset period of at least one of a plurality of subfields constituting a frame, depending on an average power level (APL).

Although FIG. 1 has shown a case where the driver 110 is formed in the form of a signal board, the driver 110 may be formed in the form of a plurality of boards depending on the electrodes on the plasma display panel 100. For example, the driver 110 may include a first driver (not shown) for driving the scan electrodes Y1 to Yn, a second driver (not shown) for driving the sustain electrodes Z1 to Zn, and a third driver (not shown) for driving the address electrodes X1 to Xm.

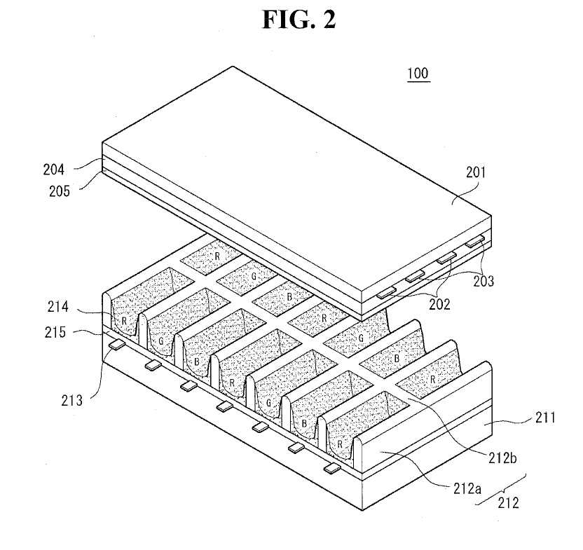

FIG. 2 illustrates a structure of the plasma display panel 100.

As shown in FIG. 2, the plasma display panel may include a front substrate 201, on which a scan electrode 202 and a sustain electrode 203 are positioned parallel to each other, and a rear substrate 211 on which an address electrode 213 is positioned to intersect the scan electrode 202 and the sustain electrode 203.

An upper dielectric layer 204 may be positioned on the front substrate 201, on which the scan electrode 202 and the sustain electrode 203 are positioned, to limit a discharge current of the scan electrode 202 and the sustain electrode 203 and to provide electrical insulation between the scan electrode 202 and the sustain electrode 203.

A protective layer 205 may be positioned on the front substrate 201, on which the upper dielectric layer 204 is positioned, to facilitate discharge conditions. The protective layer 205 may be formed of a material having a high secondary electron emission coefficient, for example, magnesium oxide (MgO).

A lower dielectric layer 215 may be positioned on the rear substrate 211, on which the address electrode 213 is positioned, to cover the address electrode 213 and to provide electrical insulation of the address electrodes 213.

Barrier ribs 212 of a stripe type, a well type, a delta type, a honeycomb type, and the like, may be positioned on the lower dielectric layer 215 to partition discharge spaces, i.e., discharge cells. Hence, a first discharge cell emitting red light, a second discharge cell emitting blue light, and a third discharge cell emitting green light, and the like, may be positioned between the front substrate 201 and the rear substrate 211.

The barrier rib 212 may have various forms of structures as well as a structure shown in FIG. 2. For example, the barrier rib 212 includes a first barrier rib 212b and a second barrier rib 212a. The barrier rib 212 may have a differential type barrier rib structure in which heights of the first and second barrier ribs 212b and 212a are different from each other, a channel type barrier rib structure in which a channel usable as an exhaust path is formed on at least one of the first barrier rib 212b or the second barrier rib 212a, a hollow type barrier rib structure in which a hollow is formed on at least one of the first barrier rib 212b or the second barrier rib 212a, and the like.

In the differential type barrier rib structure, a height of the first barrier rib 212b may be smaller than a height of the second barrier rib 212a. In the channel type barrier rib structure, a channel may be formed on the first barrier rib 212b.

Each of the discharge cells partitioned by the barrier ribs 212 may be filled with a discharge gas.

A phosphor layer 214 may be positioned inside the discharge cells to emit visible light for an image display during an address discharge. For example, a first phosphor layer emitting red light, a second phosphor layer emitting blue light, and a third phosphor layer emitting green light may be positioned.

While the address electrode 213 may have a substantially constant width or thickness, a width or thickness of the address electrode 213 inside the discharge cell may be different from a width or thickness of the address electrode 213 outside the discharge cell. For example, a width or thickness of the address electrode 213 inside the discharge cell may be larger than a width or thickness of the address electrode 213 outside the discharge cell.

When a predetermined signal is supplied to at least one of the scan electrode 202, the sustain electrode 203, and the address electrode 213, a discharge occurs inside the discharge cell. Hence, ultraviolet rays are generated by the discharge gas filled in the discharge cell because of the discharge, and are emitted on phosphor particles of the phosphor layer 214. Then, the phosphor particles emit visible light to thereby display an image on the screen of the plasma display panel.

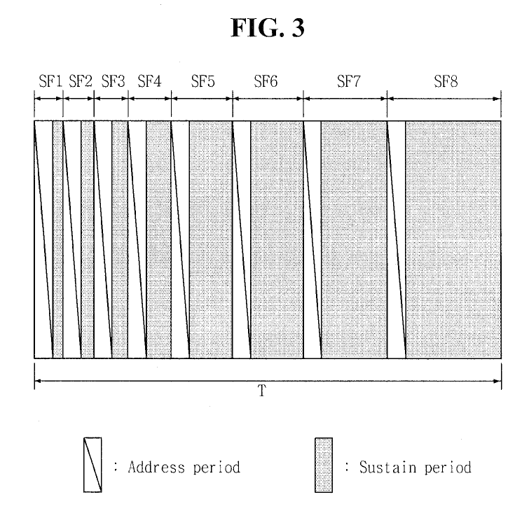

FIG. 3 illustrates a frame for achieving a gray level of an image in the plasma display apparatus.

As shown in FIG. 3, a frame may include a plurality of subfields. Each subfield may be divided into an address period and a sustain period. During the address period, the discharge cells not to generate a discharge are selected or the discharge cells to generate a discharge are selected. During the sustain period, gray levels are achieved depending on the number of discharges.

For example, as shown in FIG. 3, if an image with 256 gray levels is to be displayed, a frame may be divided into 8 subfields SF1 to SF8. Each of the 8 subfields SF1 to SF8 may be subdivided into an address period and a sustain period.

The number of sustain signals supplied during the sustain period determines a gray level of each of the subfields. For example, in such a method of setting a gray level of a first subfield at 2⁰ and a gray level of a second subfield at 2¹, the sustain period increases in a ratio of 2ⁿ (where, n=0, 1, 2, 3, 4, 5, 6, 7) in each of the subfields. Hence, various gray levels of an image can be achieved by controlling the number of sustain signals supplied during the sustain period of each subfield depending on the gray level of each subfield.

In FIG. 3, while one frame includes 8 subfields, the number of subfields constituting one frame may vary. For example, one frame may include 12 subfields or 10 subfields. Further, while the subfields of one frame are arranged in increasing order of gray levels in FIG. 3, the subfields may be arranged in decreasing order of gray levels, or may be arranged regardless of the gray level.

At least one of the plurality of subfields of one frame may be a selective write subfield, and at least one of the other subfields may be a selective erase subfield.

If a frame includes at least one selective write subfield and at least one selective erase subfield, it may be preferable that a first subfield of a plurality of subfields of the frame is a selective write subfield and the other subfields are selective erase subfields. Or, all the subfields of the frame may be selective erase subfields.

The selective erase subfield is a subfield in which the discharge cell where a data signal is supplied to the address electrode during an address period is turned off during a sustain period following the address period. The selective write subfield is a subfield in which the discharge cell where a data signal is supplied to the address electrode during an address period is turned on during a sustain period following the address period.

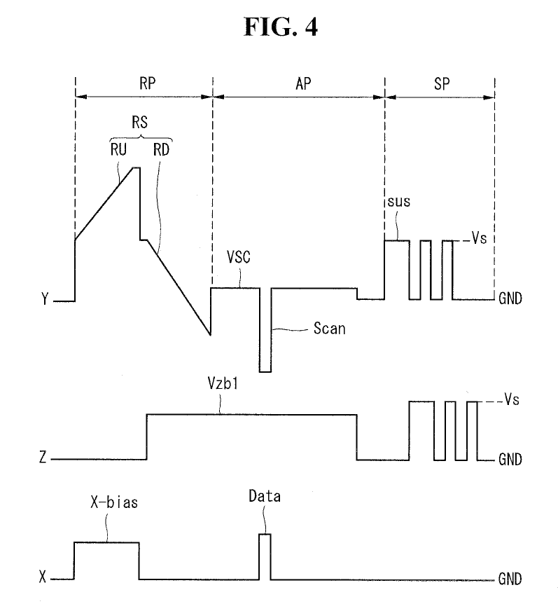

FIG. 4 illustrates an example of an operation of the plasma display apparatus.

As shown in FIG. 4, during a reset period RP for initialization of a subfield, a reset signal RS is supplied to the scan electrode Y. The reset signal RS includes a rising signal RU and a falling signal RD. The rising signal RU is supplied to the scan electrode Y to thereby generate a weak dark discharge (i.e., a setup discharge) inside the discharge cells. Hence, wall charges can be uniformly distributed inside the discharge cells.

During the supplying of the rising signal RU to the scan electrode Y, an address bias signal X-bias is supplied to the address electrode X. The address bias signal X-bias reduces a voltage difference between the scan electrode Y and the address electrode X during the supplying of the rising signal RU, thereby preventing the setup discharge from occurring excessively toward the address electrode X. Hence, a deterioration of the phosphor layer and the generation of image sticking can be suppressed.

After the supplying of the rising signal RU, the falling signal RD is supplied to the scan electrode Y to thereby generate a weak erase discharge (i.e., a set-down discharge) inside the discharge cells. Hence, the remaining wall charges are uniform inside the discharge cells to the extent that an address discharge can stably occur inside the discharge cells.

During an address period AP following the reset period RP, a scan bias signal VSC, which has a voltage higher than a lowest voltage of the falling signal RD, is supplied to the scan electrode Y. A scan signal Scan falling from the scan bias signal VSC is supplied to the scan electrode Y.

A pulse width of a scan signal supplied to the scan electrode during an address period of at least one subfield of a frame may be different from pulse widths of scan signals supplied during address periods of the other subfields of the frame. A pulse width of a scan signal in a subfield may be larger than a pulse width of a scan signal in a next subfield in time order. For example, a pulse width of the scan signal may be gradually reduced in the order of 2.6 μs, 2.3 μs, 2.1 μs, 1.9 μs, etc., or may be reduced in the order of 2.6 μs, 2.3 μs, 2.3 μs, 2.1 μs, . . . , 1.9 μs, 1.9 μs, etc. in the successively arranged subfields.

When the scan signal Scan is supplied to the scan electrode Y, a data signal Data corresponding to the scan signal Scan is supplied to the address electrode X. As the voltage difference between the scan signal Scan and the data signal Data is added to the wall voltage produced during the reset period RP, an address discharge occurs inside the discharge cell to which the data signal Data is supplied. During the address period AP, a first sustain bias signal Vzb1 corresponding to the scan bias signal VSC is supplied to the sustain electrode Z, thereby preventing the address discharge from unstably occurring by interference of the sustain electrode Z.

During a sustain period SP following the address period AP, a sustain signal sus may be supplied to at least one of the scan electrode Y or the sustain electrode Z. For example, the sustain signal sus is alternately supplied to the scan electrode Y and the sustain electrode Z. As the wall voltage inside the discharge cell selected by performing the address discharge is added to a sustain voltage Vs of the sustain signal sus, every time the sustain signal sus is supplied, a sustain discharge, i.e., a display discharge occurs between the scan electrode Y and the sustain electrode Z.

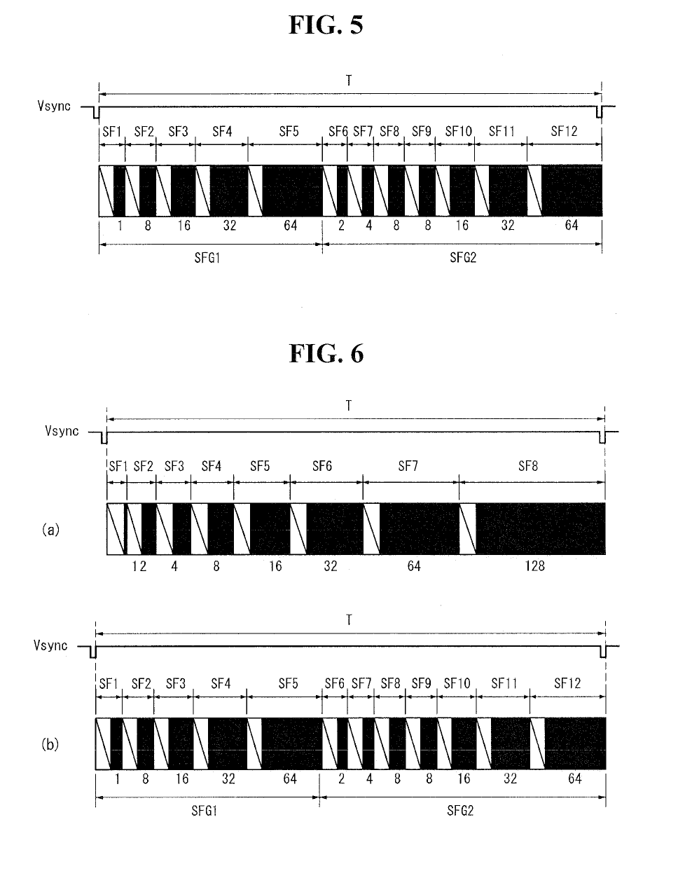

FIG. 5 illustrates a frame comprised of a plurality of subfield groups.

A frame may include a plurality of subfield groups each including a plurality of subfields. For example, as shown in FIG. 5, a frame may include a first subfield group SFG1 including 1st to 5th subfields SF1 to SF5 and a second subfield group SFG2 including 6th to 12th subfields SF6 to SF12.

In the first and second subfield groups SFG1 and SFG2, the subfields may be arranged in increasing order of gray levels. For example, in the first and second subfield groups SFG1 and SFG2, a subfield having a minimum gray level is first arranged, and a subfield having a maximum gray level is lastly arranged.

While one frame includes the two subfield groups in FIG. 5, one frame may include 3 or more subfield groups. Further, the number of subfields belonging to one subfield group may be variously changed.

FIG. 6 illustrates a reason to divide a frame into a plurality of subfield groups.

In FIG. 6, (a) illustrates a case where a frame is not divided into a plurality of subfield groups, and (b) illustrates a case where a frame is divided into a plurality of subfield groups.

For example, it is assumed that one frame includes 8 subfields SF1 to SF8 in (a) of FIG. 6, and one frame includes a first subfield group SFG1 including 1st to 5th subfields SF1 to SF5 and a second subfield group SFG2 including 6th to 12th subfields SF6 to SF12 in (b) of FIG. 6.

In (a) of FIG. 6, a sum of gray levels is 255 (=1+2+4+8+16+32+64+128), and 256 gray values can be represented. In (b) of FIG. 6, a sum of gray levels is 255 (=1+2+4+8+8+8)+(16+16)+(32+32)+(64+64)), and 256 gray values can be represented.

As above, the case of (b) of FIG. 6 can represent the same gray level as the case of (a) of FIG. 6. Further, in the case of (b) of FIG. 6, because a viewer can perceive an image of one frame as images of two frames, a phenomenon whereby a display screen appears to flicker can be reduced.

The flicker generally occurs when an afterglow time of the phosphor is shorter than a frequency of a vertical sync signal Vsync of a video signal. For example, when a frequency of a vertical sync signal Vsync is 60 Hz, an image of one frame is displayed for 16.67 ms. When a reaction speed of the phosphor layer is larger than 60 Hz, the flicker may occur. Further, when the frequency of the vertical sync signal Vsync is relatively low, the flicker may worsen.

On the other hand, as shown in (b) of FIG. 6, when one frame includes the first subfield group SFG1 capable of representing 121 gray values and the second subfield group SFG2 capable of representing 135 gray values, two frames capable of respectively representing the 121 gray values and the 135 gray values can be obtained using one frame capable of representing 256 gray values. Hence, an effect in which the vertical frequency increases to two times can be obtained, and thus the generation of flicker can be reduced.

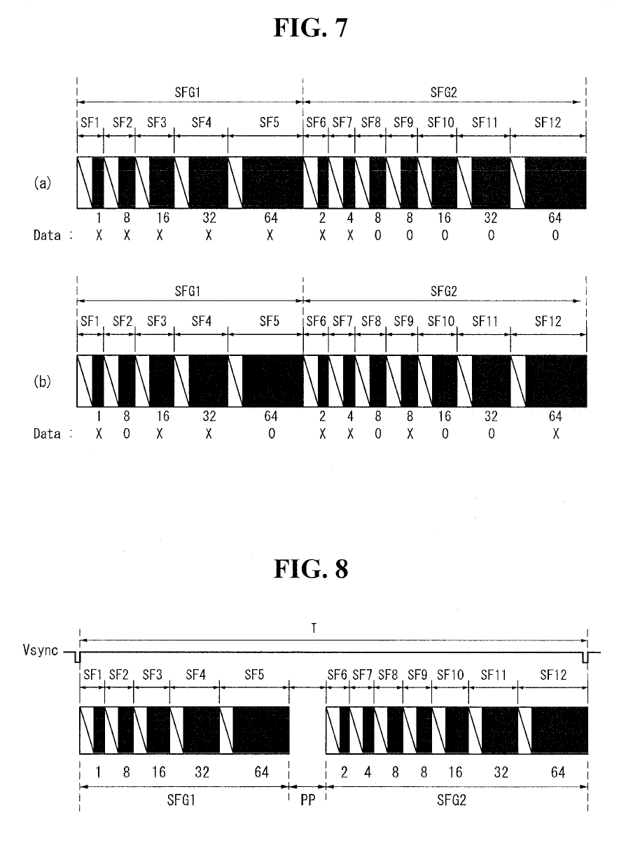

FIG. 7 illustrates a method for processing video data of a frame comprised of a plurality of subfield groups.

As shown in FIG. 7, there are mainly two methods for dividing one frame into a plurality of subfields groups. In FIG. 7, ∘ means that a corresponding subfield is turned on. In other words, a data signal is supplied during an address period of the corresponding subfield.

In a first method, video data of one frame is considered as video data of one frame. If an image with 128 gray levels is to be displayed, as shown in (a) of FIG. 7, a 8th subfield with 8 gray levels, a 9th subfield with 8 gray levels, a 10th subfield with 16 gray levels, a 11th subfield with 32 gray levels, and a 12th subfield with 64 gray levels are turned on.

In the first method, an image of a first subfield group SFG1 may be greatly different from an image of a second subfield group SFG2. In other words, this may mean that video data of the first subfield group SFG1 and video data of the second subfield group SFG2 greatly change.

In a second method, video data of one frame is considered as video data of two frames. In this case, an image of one frame is considered as a sum of images of two subfield groups. If an image with 128 gray levels is to be displayed, as shown in (b) of FIG. 7, a 2nd subfield with 8 gray levels and a 5th subfield with 64 gray levels in a first subfield group SFG1 are turned on and a 8th subfield with 8 gray levels, a 10th subfield with 16 gray levels, and a 11th subfield with 32 gray levels in a second subfield group SFG2 are turned on. In other words, an image with 72 gray levels is displayed in the first subfield group SFG1, and an image with 56 gray levels is displayed in the second subfield group SFG2.

In the second method, an image of the first subfield group SFG1 may be the same as or very similar to an image of the second subfield group SFG2. In other words, this may mean that video data of the first subfield group SFG1 and video data of the second subfield group SFG2 slightly change.

FIG. 8 illustrates a pause period.

A pause period may be arranged between two subfields groups of a plurality of subfields groups. For example, as shown in FIG. 8, if one frame includes a first subfield group SFG1 and a second subfield group SFG2, a pause period PP may be arranged between the first subfield group SFG1 and the second subfield group SFG2.

The pause period may be a period during which a driving signal for an image display is not supplied to the scan electrode, the sustain electrode, and the address electrode, or a specific voltage such as a ground level voltage GND is supplied and hold.

As above, an image of one frame can be uniformly divided into an image of the first subfield group SFG1 and an image of the second subfield group SFG2 by arranging the pause period PP between the first subfield group SFG1 and the second subfield group SFG2. Hence, the flicker can be reduced.

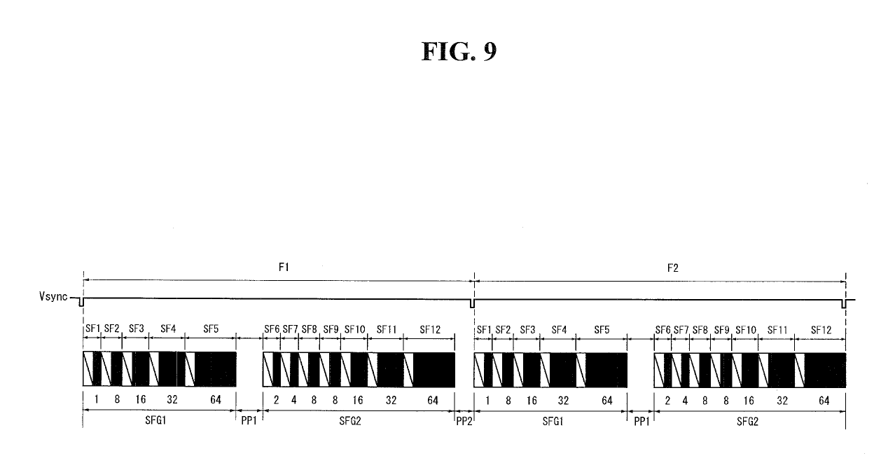

FIG. 9 illustrates another method for arranging a pause period.

A pause period may be arranged between any two subfield groups of a frame, and another pause period may be arranged between a last subfield group of the frame and a first subfield group of a next frame. For example, as shown in FIG. 9, if two frames F1 and F2 each include a first subfield group SFG1 and a second subfield group SFG2, pause periods PP1 may be arranged between the first subfield group SFG1 and the second subfield group SFG2 of each of the first and second frames F1 and F2, and a pause period PP2 may be arranged between the second subfield group SFG2 of the first frame F1 and the first subfield group SFG1 of the second frame F2.

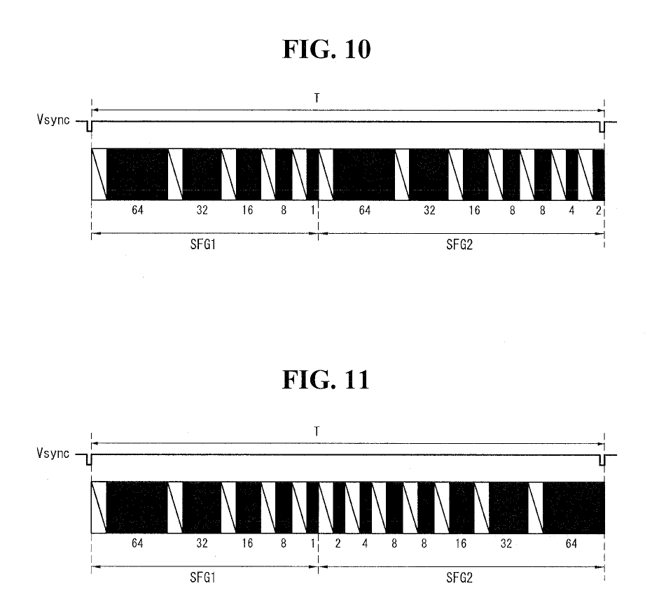

FIG. 10 illustrates a method for arranging subfields.

As shown in FIG. 10, a plurality of subfields belonging to each of a plurality of subfield groups may be arranged in decreasing order of gray levels. For example, as shown in FIG. 10, if a frame includes a first subfield group SFG1 and a second subfield group SFG2, a subfield with a maximum gray level may be first arranged in each of the first and second subfield groups SFG1 and SFG2, the remaining subfields may be arranged in decreasing order of gray levels.

FIG. 11 illustrates another method for arranging subfields.

An arrangement of subfields belonging to at least one of a plurality of subfield groups may be different from an arrangement of subfields belonging to the other subfield groups. For example, as shown in FIG. 11, if a frame includes a first subfield group SFG1 and a second subfield group SFG2, subfields of the first subfield group SFG1 may be arranged in decreasing order of gray levels, and subfields of the second subfield group SFG2 may be arranged in increasing order of gray levels.

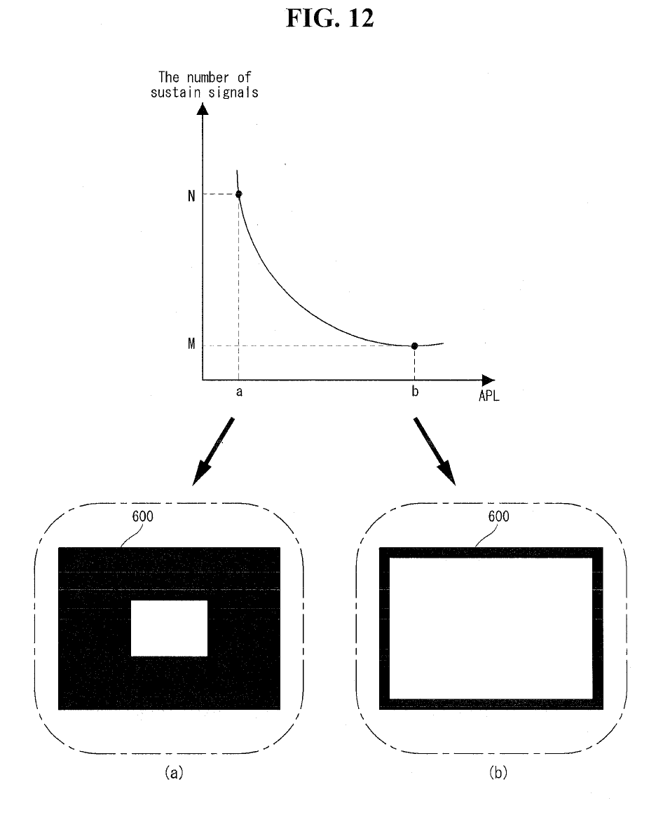

FIG. 12 illustrates an average power level (APL).

The number of sustain signals may be controlled in consideration of an average power level (APL). More specifically, the number of sustain signals assigned to a frame decreases as the APL increases, and the number of sustain signals assigned to a frame increases as the APL decreases.

For example, as shown in (a) of FIG. 12, when an image with a relatively small area is displayed on the screen of the plasma display panel, an APL may be relatively low because of low power consumption. Therefore, an entire luminance of the image can increase by increasing the number of sustain signals assigned to a frame.

On the contrary, as shown in (b) of FIG. 12, when an image with a relatively large area is displayed on the screen of the plasma display panel, an APL may be relatively high because of high power consumption. Therefore, an excessive increase in the power consumption can be prevented by reducing the number of sustain signals assigned to a frame.

As shown in FIG. 12, when the APL is a-level, the number of sustain signals per gray level is N. When the APL is b-level higher than the a-level, the number of sustain signals per gray level is M less than N.

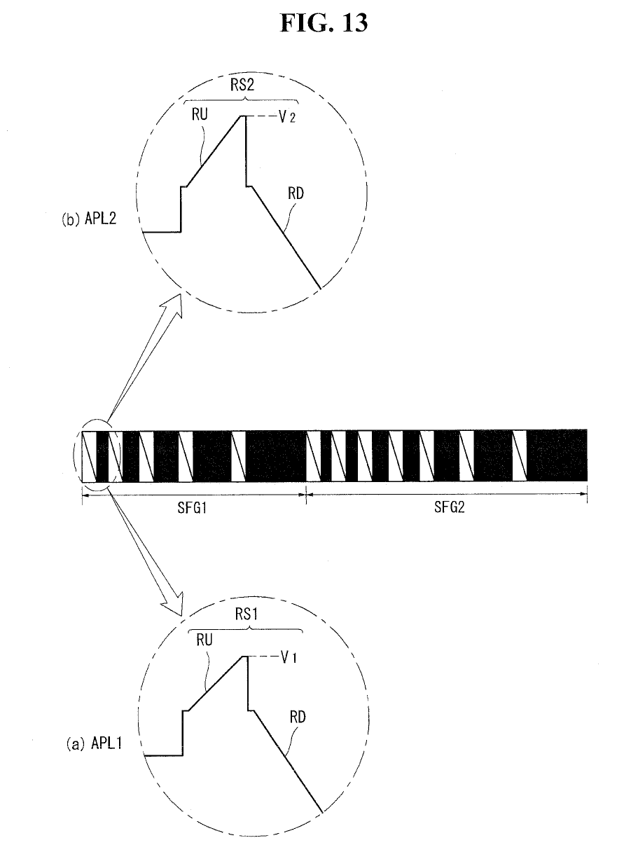

FIG. 13 illustrates a method for controlling a voltage of a reset signal depending on an APL.

A maximum voltage of a reset signal supplied to the scan electrode during a reset period can be controlled in at least one of a plurality of subfields depending on an APL.

As shown in (a) of FIG. 13, when the APL is APL1, a maximum voltage of a reset signal RS1 supplied to the scan electrode during a reset period of a first subfield of a first subfield group SFG1 may be V1. As shown in (b) of FIG. 13, when the APL is APL2 larger than the APL1, a maximum voltage of a reset signal RS2 may be V2 different from V1. The voltage V2 may be larger than the voltage V1.

A rate of voltage change over time in a rising signal RU of the reset signal RS1 may be smaller than a rate of voltage change over time in a rising signal RU of the reset signal RS2. The maximum voltage of the reset signal can be controlled by controlling the rate of voltage change over time in the rising signal.

Although FIG. 13 illustrates the case where the maximum voltage of the reset signal is controlled in only the first subfield of the first subfield group SFG1 among two subfield groups SFG1 and SFG2 constituting one frame depending on the APL, the maximum voltage of the reset signal may be controlled in at least one subfield of each subfield group depending on the APL.

A reason to control the maximum voltage of the reset signal depending on the APL is as follows.

When the APL is relatively low, a large number of sustain signals per gray level are supplied. Hence, a sustain discharge can stably occur during a sustain period of a subfield, and a reset discharge can stably occur during a reset period of a next subfield.

On the contrary, when the APL is relatively high, a small number of sustain signals per gray level are supplied. Hence, because the number of sustain signals supplied during a sustain period of a specific subfield excessively decreases, a sustain discharge may unstably occur. Further, a reset discharge may unstably occur during a reset period of a next subfield.

Accordingly, even if a small number of sustain signals per gray level are supplied at a relatively high APL, a sustain discharge can be prevented from unstably occurring by increasing a maximum voltage of a reset signal supplied during a reset period of at least one subfield.

If one frame is divided into a plurality of subfield groups each including a plurality of subfields, the number of subfields with a low gray level may increase in the one frame.

For example, as shown in (a) of FIG. 6, when one frame is not divided into a plurality of subfield groups, the number of subfields having 8 or less gray levels is 2. On the other hand, as shown in (b) of FIG. 6, when one frame includes a plurality of subfield groups, the number of subfields having 8 or less gray levels is 6.

When the number of sustain signals per gray level decreases because of an increase in the APL, the number of subfields, in which a sustain discharge will unstably occur, increases.

Accordingly, when one frame includes a plurality of subfield groups each including a plurality of subfields, it may be preferable to control a magnitude of a maximum voltage of a reset signal depending on the APL.

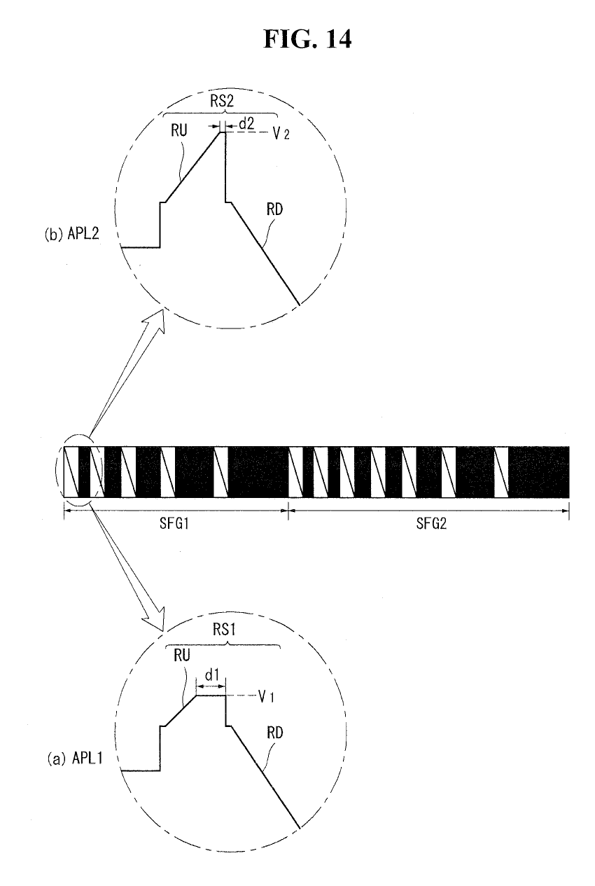

FIG. 14 illustrates another method for controlling a voltage of a reset signal depending on an APL. In FIG. 14, the same description as the description illustrated in FIG. 13 is omitted.

As shown in FIG. 14, a rate of voltage change over time in a rising signal RU of a reset signal RS1 when the APL is APL1 is equal to a rate of voltage change over time in a rising signal RU of a reset signal RS2 when the APL is APL2. Further, a hold period d1 of a maximum voltage V1 of the reset signal RS1 is different from a hold period d2 of a maximum voltage V2 of the reset signal RS2. Hence, the maximum voltage of the reset signal can be controlled depending on an APL.

The maximum voltage V1 of the reset signal RS1 may be smaller than the maximum voltage V2 of the reset signal RS2 by allowing the hold period d1 of the maximum voltage V1 of the reset signal RS1 to be longer than the hold period d2 of the maximum voltage V2 of the reset signal RS2.

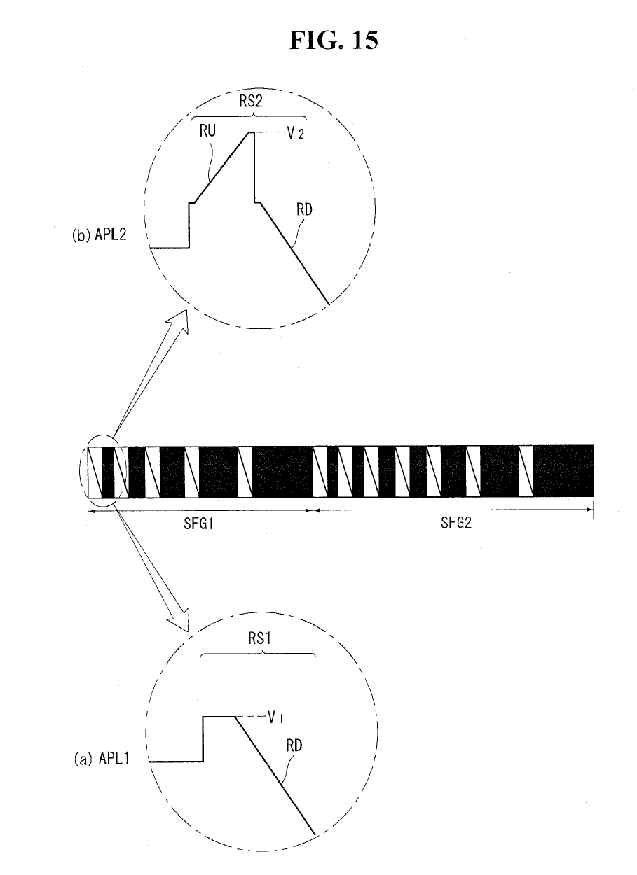

FIG. 15 illustrates another method for controlling a voltage of a reset signal depending on an APL. In FIG. 15, the same description as the descriptions illustrated in FIGS. 13 and 14 is omitted.

As shown in FIG. 15, when the APL is APL1, a reset signal RS1 includes only a falling signal RD with a gradually falling voltage. When the APL is APL2 higher than the APL1, a reset signal RS2 includes a rising signal RU with a gradually rising voltage and a falling signal RD with a gradually falling voltage. Hence, a maximum voltage of the reset signal can be controlled depending on the APL.

Preferably, because the reset signal RS1 does not include the rising signal and the reset signal RS2 includes the rising signal depending on the APL, a maximum voltage V1 of the reset signal RS1 may be smaller than a maximum voltage V2 of the reset signal RS2.

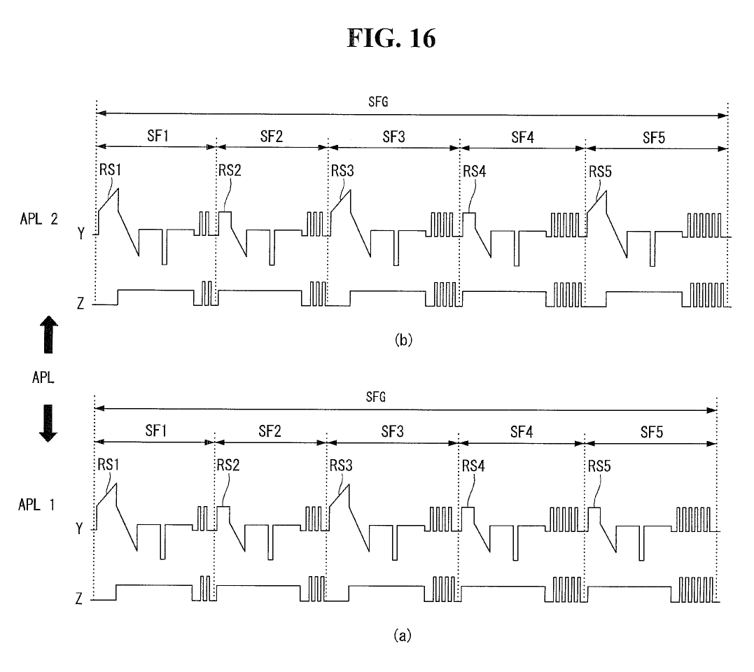

FIG. 16 illustrates a method for controlling the number of subfields, in which a rising signal is supplied to the scan electrode Y, depending on an APL.

It is assumed that a subfield group includes 1st to 5th subfields SF1 to SF5. When the APL is APL1, as shown in (a) of FIG. 16, a rising signal and a falling signal are supplied in the 1st and 3rd subfields, and only a falling signal is supplied in the 2nd, 4th, and 5th subfields. Further, when the APL is APL2 higher than the APL1, as shown in (b) of FIG. 16, a rising signal and a falling signal are supplied in the 1st, 3rd, and 5th subfields, and only a falling signal is supplied in the 2nd and 4th subfields.

In other words, when the APL is the APL1, a rising signal is supplied in n subfields, where n is a natural number. When the APL is the APL2 higher than the APL1, a rising signal is supplied in m subfields more than the n subfields.

As above, even if one frame is divided into a plurality of subfield groups each including a plurality of subfields, a sustain discharge and a reset discharge can be prevented from unstably occurring by controlling the number of subfields, in which a rising signal is supplied to the scan electrode Y, depending on the APL.

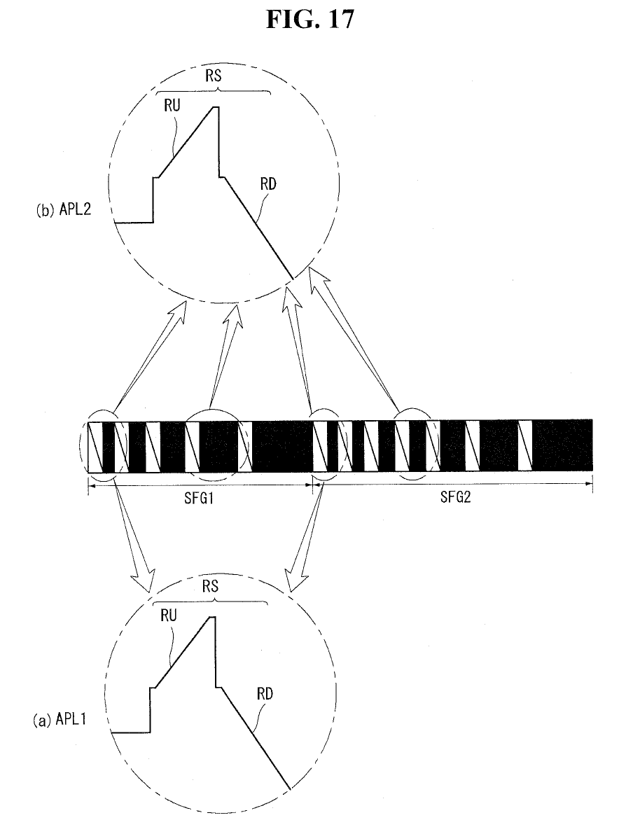

FIG. 17 illustrates another method for controlling the number of subfields, in which a rising signal is supplied, depending on an APL.

As shown in FIG. 17, the number of subfields, in which a rising signal is supplied, can be controlled in each of a plurality of subfield groups of one frame depending on an APL.

It is assumed that a frame includes a first subfield group SFG1 and a second subfield group SFG2. When the APL is APL1, as shown in (a) of FIG. 17, a rising signal is supplied to the scan electrode in a 1st subfield of the first subfield group SFG1 and a 6th subfield of the second subfield group SFG2. Further, when the APL is APL2 higher than the APL1, as shown in (b) of FIG. 17, a rising signal is supplied to the scan electrode in the 1st and 4th subfields of the first subfield group SFG1 and the 6th and 10th subfields of the second subfield group SFG2.

As above, a sustain discharge and a reset discharge can more stably occur by controlling the number of subfields, in which a rising signal is supplied to the scan electrode Y, in each subfield group depending on the APL.

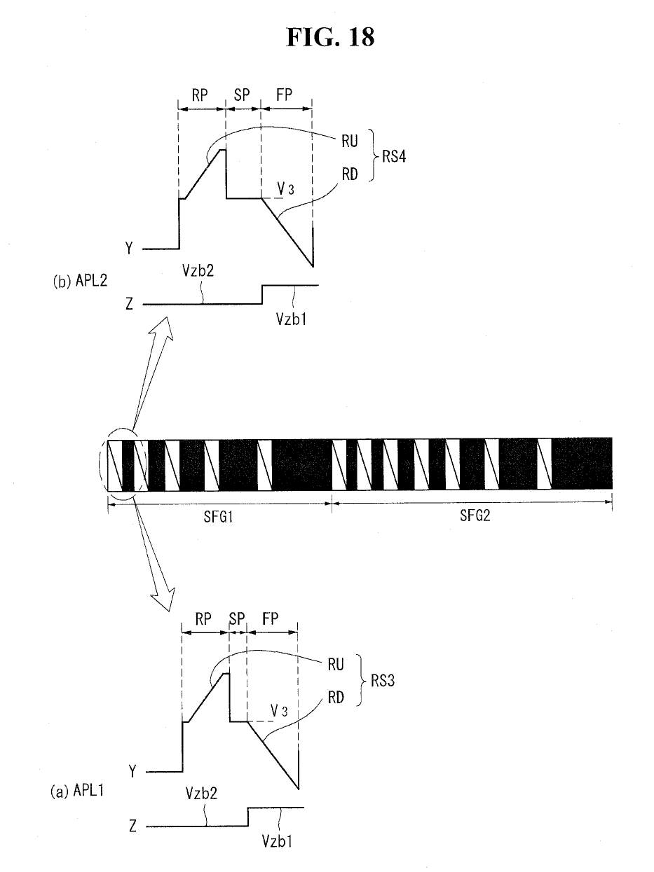

FIG. 18 illustrates a method for controlling a length of a hold period depending on an APL.

As shown in FIG. 18, a reset signal may include a rising period RP during which a rising signal RU with a gradually rising voltage is supplied, a falling period FP during which a falling signal RD with a gradually falling voltage is supplied, and a hold period SP between the rising period RP and the falling period FP, during which a maximum voltage V3 of the falling signal RD is hold.

A length of the hold period SP may be controlled depending on the APL. When the APL is APL1, a length of the hold period SP may be a first length. When the APL is APL2 higher than the APL1, a length of the hold period SP may be a second length longer than the first length.

The maximum voltage V3 of the falling signal RD may be substantially equal to a voltage Vs of a sustain signal supplied to at least one of the scan electrode Y or the sustain electrode Z during a sustain period.

If the length of the hold period SP increases, wall charges can be stably distributed inside the discharge cells during the hold period SP. Accordingly, even if one frame is divided into a plurality of subfield groups each including a plurality of subfields, a reset discharge and a sustain discharge can be prevented from unstably occurring at the relatively high APL by lengthening the length of the hold period SP of the maximum voltage V3 of the falling signal RD.

It may be preferable that a first sustain bias signal Vzb1 is supplied to the sustain electrode during the falling period FP and a second sustain bias signal Vzb2 having a voltage smaller than a voltage of the first sustain bias signal Vzb1 is supplied to the sustain electrode during the hold period SP, so as to prevent a discharge from unstably occurring during the hold period SP and the falling period FP. The voltage of the second sustain bias signal Vzb2 may be substantially equal to the ground level voltage GND, and the voltage of the first sustain bias signal Vzb1 may be larger than the ground level voltage GND and may be smaller than the sustain voltage Vs.

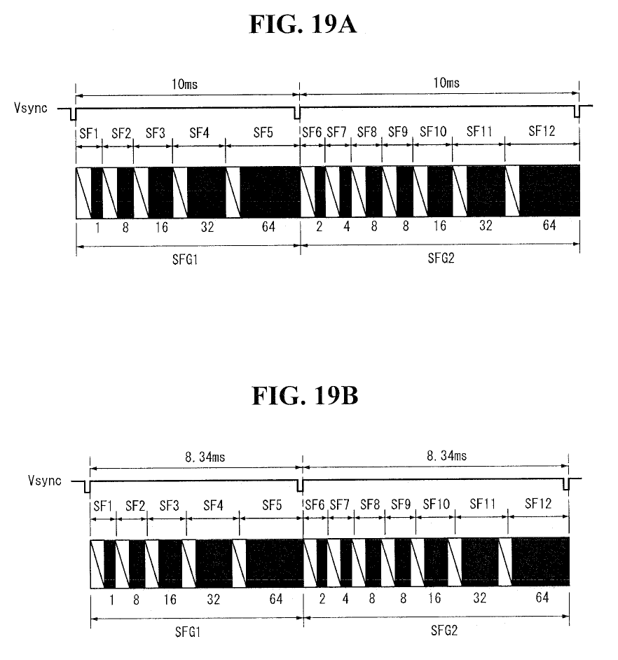

FIGS. 19A and 19B illustrate a method for dividing a frame into a plurality of subfield groups.

Although only the case a plurality of subfield groups are included in 1 period of a vertical sync signal Vsync was described above, subfield groups may be distinguished using the vertical sync signal Vsync.

For example, in FIG. 5, two subfield groups are included in 1 period of a vertical sync signal Vsync. In FIG. 19A, another vertical sync signal is arranged between first and second subfield groups, and thus the first and second subfield groups can be distinguished.

When a length of one frame is approximately 20 ms in FIG. 5, a length of each subfield group may be approximately 10 ms in FIG. 19A. Further, when a length of one frame is approximately 16.67 ms in FIG. 5, a length of each subfield group may be approximately 8.34 ms in FIG. 19B.

As above, when the vertical sync signal Vsync is used to distinguish the subfield groups, a frequency of input video data has to increase by the number of subfield groups. For example, if video data of 50 Hz is input and one frame is divided into two subfield groups, the video data of 50 Hz has to increase by twice.

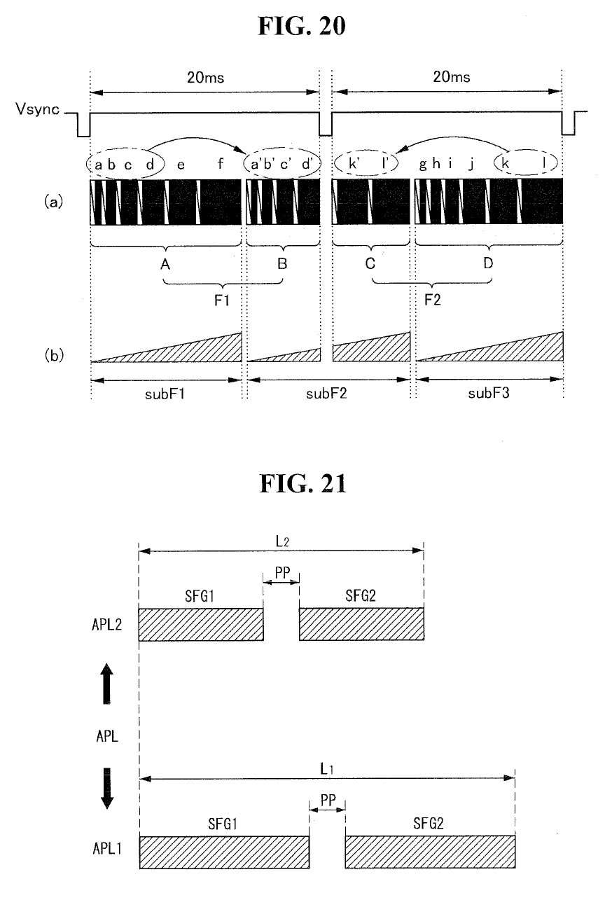

FIG. 20 illustrates a method for dividing a frame into a plurality of subfield groups. In FIG. 20, the same description as the description illustrated above is omitted.

As shown in FIG. 20, two successive frames each include two subfield groups. More specifically, a first frame F1 may include a 1-1-subfield group A and a 1-2 subfield group B each including at least one subfield. A second frame F2 immediately following the first frame F1 may include a 2-1 subfield group C and a 2-2 subfield group D each including at least one subfield. If a length of each of the first and second frames F1 and F2 is 20 ms, a length of each of sub-frames subF1, subF2, and subF3 is 13.34 ms.

The first sub-frame subF1 may be comprised of the 1-1 subfield group A, the second sub-frame subF2 may be comprised of the 1-2 subfield group B and the 2-1 subfield group C, and the third sub-frame subF2 may be comprised of the 2-2 subfield group D. As a result, a viewer can perceive an image displayed in two frames as an image displayed in three frames. Hence, the image quality can be improved, and the flicker can be reduced.

Vided data of the second sub-frame subF2 may have a middle value of the first sub-frame subF1 and the third sub-frame subF3. For this, at least one of the subfields belonging to the 1-1 subfield group A may be identical to at least one of the subfields belonging to the 1-2 subfield group B, and at least one of the subfields belonging to the 2-1 subfield group C may be identical to at least one of the subfields belonging to the 2-2 subfield group D. In other words, the 1-1 subfield group A and the 1-2 subfield group B are partially identical, and the 2-1 subfield group C and the 2-2 subfield group D are partially identical. For example, a first subfield “a” of the 1-1 subfield group A is identical to a first subfield “a′” of the 1-2 subfield group B, and a first subfield “k′” of the 2-1 subfield group C is identical to a fifth subfield “k” of the 2-2 subfield group D.

The fact that two subfields are identical may mean signal operations during reset periods, address periods, and sustain periods of the two identical subfields are identical.

Preferably, all the subfields belonging to the 1-2 subfield group B may be identical to some subfields of the 1-1 subfield group A, and all the subfields belonging to the 2-1 subfield group C may be identical to some subfields of the 2-2 subfield group D. For example, as shown in (a) of FIG. 20, all the subfields a′, b′, c′ and d′ of the 1-2 subfield group B are identical to some subfields a, b, c and d of the 1-1 subfield group A, respectively. All the subfields k′ and l′ of the 2-1 subfield group C are identical to some subfields k and l of the 2-2 subfield group D, respectively.

As shown in (b) of FIG. 20, video data of the second sub-frame subF2 may have a middle value of video data of the first sub-frame subF1 and video data of the third sub-frame subF3.

Since FIG. 20 illustrates an example of various methods for allowing the second sub-frame subF2 to have a middle value of the first sub-frame subF1 and the third sub-frame subF3, the exemplary embodiment is not limited thereto.

FIGS. 21 to 23 illustrate changes in a length of a pause period depending on an APL and a driving method of the plasma display apparatus. In FIGS. 21 to 23, the same description as the description illustrated above is omitted.

As shown in FIG. 21, even if the APL changes, there is no substantial charge in a length of a pause period pp between any two subfield groups SFG1 and SFG2 of a plurality of subfield groups of a frame.

A length L1 of a period, during which driving signals are supplied in one frame, when the APL is APL1 may be longer than a length L2 of a period, during which driving signals are supplied in one frame, when the APL is APL2 higher than the APL1.

As shown in FIG. 21, when a length of a pause period pp between first and second subfield groups SFG1 and SFG2 is substantially equal to each other at the APL1 and the APL2, a distribution state of wall charges inside the discharge cells during a period from an end time point of the first subfield group SFG1 to a start time point of the second subfield group SFG2 may be similar to each other at the APL1 and the APL2.

In FIG. 21, a maximum voltage of a reset signal supplied during a reset period of at least one subfield of the first subfield group SFG1 among the first and second subfield groups SFG1 and SFG2 may have different values at the APL1 and the APL2 as in FIGS. 13 to 15. In other words, if the APL changes, there is no substantial change in a maximum voltage of a reset signal in the second subfield group SFG2, and the maximum voltage of the reset signal changes in only the first subfield group SFG1 depending on the APL. The method for controlling the maximum voltage of the reset signal was described with reference to FIGS. 13 to 15.

In FIG. 21, the number of subfields in which a rising signal is supplied in the first subfield group SFG1 among the first and second subfield groups SFG1 and SFG2 may be different from each other at the APL1 and the APL2 as in FIGS. 16 and 17. The method for controlling the number of subfields in which the rising signal is supplied was described with reference to FIGS. 16 and 17.

In FIG. 21, a length of a hold period of a maximum voltage of a falling signal supplied during a reset period of at least one subfield of the first subfield group SFG1 among the first and second subfield groups SFG1 and SFG2 may have different values at the APL1 and the APL2 as in FIG. 18. The method for controlling the length of the hold period was described with reference to FIG. 18.

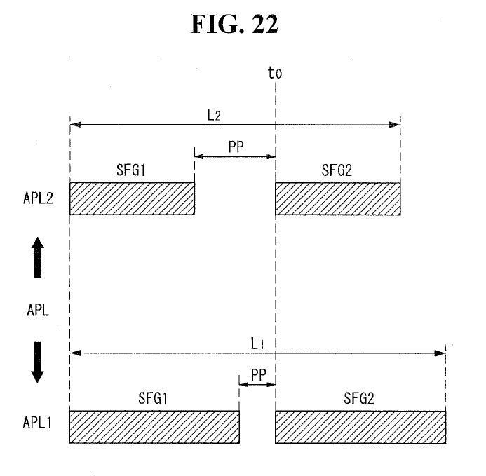

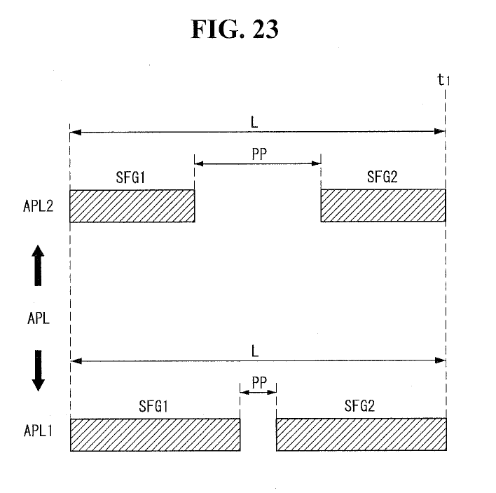

As shown in FIGS. 22 and 23, a length of a pause period PP between any two subfield groups SFG1 and SFG2 of a plurality of subfield groups of a frame may change depending on changes in an APL. More specifically, a length of a pause period PP at APL1 may be shorter than a length of a pause period PP at APL2 higher than the APL1.

For example, as shown in FIG. 22, a start time point t0 of the second subfield group SFG2 may be the same at the APL1 and APL2. In this case, a length of a pause period PP at the APL2 may be longer than a length of a pause period PP at the APL1, and a length L1 of a period during which driving signals are supplied in one frame at the APL1 may be longer than a length L2 of a period during which driving signals are supplied in one frame at the APL2.

As shown in FIG. 23, an end time point t1 of the second subfield group SFG2 may be the same at the APL1 and APL2. In this case, a length of a pause period PP at the APL2 may be longer than a length of a pause period PP at the APL1, and a length L of a period during which driving signals are supplied in one frame at the APL1 may be substantially equal to a length L of a period during which driving signals are supplied in one frame at the APL2.

As shown in FIGS. 22 and 23, when the length of the pause period PP at the APL2 is longer than the length of the pause period PP at the APL1, changes in a distribution state of wall charges inside the discharge cells during a period from an end time point of the first subfield group SFG1 to a start time point of the second subfield group SFG2 at the APL2 may be more than changes in a distribution state of wall charges at the APL1.

For example, the amount of wall charges erased during the pause period PP at the APL2 is more than the amount of wall charges erased during the pause period PP at the APL1. In this case, a discharge may unstably occur in the second subfield group SFG2 as well as the first subfield group SFG1 because of changes in the APL. Accordingly, it may be preferable that a maximum voltage of a reset signal supplied during a reset period of at least one subfield of each of the first and second subfield groups SFG1 and has different values at the APL1 and APL2. Further, it may be preferable that the number of subfields in which a rising signal is supplied in each of the first and second subfield groups SFG1 and SFG2 is controlled depending on the APL. Further, it may be preferable that a length of a hold period of a maximum voltage of a falling signal supplied during a reset period of at least one subfield of each of the first and second subfield groups SFG1 and SFG2 is controlled depending on the APL.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising;
a plasma display panel including a scan electrode; and
a driver that displays an image on the plasma display panel in a frame including a plurality of subfield groups each including a plurality of subfields,
wherein the driver controls a voltage magnitude of a reset signal, that is supplied to the scan electrode during a reset period of at least one subfield of the plurality of subfields belonging to each of the plurality of subfield groups of the frame, depending on an average power level (APL).

2. The plasma display apparatus of claim 1, wherein when the APL is a first level, a maximum voltage of the reset signal is a first voltage,
wherein when the APL is a second level higher than the first level, a maximum voltage of the reset signal is a second voltage larger than the first voltage.

3. The plasma display apparatus of claim 1, wherein the reset signal includes a rising signal with a gradually rising voltage and a falling signal with a gradually falling voltage.

4. The plasma display apparatus of claim 1, wherein the reset signal includes a falling signal with a gradually falling voltage and does not include a rising signal with a gradually rising voltage.

5. The plasma display apparatus of claim 1, wherein a pause period is arranged between first and second subfield groups among the plurality of subfield groups.

6. The plasma display apparatus of claim 5, wherein a length of the pause period when the APL is a first level is substantially equal to a length of the pause period when the APL is a second level higher than the first level,
wherein a maximum voltage of the reset signal supplied to the scan electrode during a reset period of at least one subfield of the first subfield group among the first and second subfield groups has different values at the first and second levels of the APL.

7. The plasma display apparatus of claim 6, wherein the maximum voltage of the reset signal at the second level of the APL is larger than the maximum voltage of the reset signal at the first level of the APL.

8. The plasma display apparatus of claim 5, wherein a length of the pause period when the APL is a first level is shorter than a length of the pause period when the APL is a second level higher than the first level,
wherein a maximum voltage of the reset signal supplied to the scan electrode during a reset period of at least one subfield of each of the first and second subfield groups has different values at the first and second levels of the APL.

9. The plasma display apparatus of claim 8, wherein the maximum voltage of the reset signal at the second level of the APL is larger than the maximum voltage of the reset signal at the first level of the APL.

10. The plasma display apparatus of claim 1, wherein a plurality of subfields belonging to at least one subfield group of the plurality of subfield groups are arranged in increasing order of gray levels.

11. The plasma display apparatus of claim 1, wherein a plurality of subfields belonging to at least one subfield group of the plurality of subfield groups are arranged in decreasing order of gray levels.

12. A plasma display apparatus comprising;
a plasma display panel including a scan electrode; and
a driver that displays an image on the plasma display panel in a frame including a plurality of subfield groups each including a plurality of subfields,
wherein the driver controls the number of subfields, in which a rising signal with a gradually rising voltage is supplied to the scan electrode in each of the plurality of subfield groups of the frame, depending on an average power level (APL).

13. The plasma display apparatus of claim 12, wherein when the APL is a first level, the number of subfields in which the rising signal is supplied is n, where n is a natural number,
wherein when the APL is a second level higher than the first level, the number of subfields in which the rising signal is supplied is m larger than n, where m is a natural number.

14. The plasma display apparatus of claim 12, wherein a pause period is arranged between first and second subfield groups among the plurality of subfield groups.

15. The plasma display apparatus of claim 14, wherein a length of the pause period when the APL is a first level is substantially equal to a length of the pause period when the APL is a second level higher than the first level,
wherein the number of subfields, in which the rising signal is supplied to the scan electrode in the first subfield group among the first and second subfield groups, has different values at the first and second levels of the APL.

16. The plasma display apparatus of claim 15, wherein the number of subfields, in which the rising signal is supplied to the scan electrode, at the second level of the APL is more than the number of subfields, in which the rising signal is supplied to the scan electrode, at the first level of the APL.

17. The plasma display apparatus of claim 14, wherein a length of the pause period when the APL is a first level is shorter than a length of the pause period when the APL is a second level higher than the first level,
wherein the number of subfields, in which the rising signal is supplied to the scan electrode, in each of the first and second subfield groups has different values at the first and second levels of the APL.

18. The plasma display apparatus of claim 17, wherein the number of subfields, in which the rising signal is supplied to the scan electrode, at the second level of the APL is more than the number of subfields, in which the rising signal is supplied to the scan electrode, at the first level of the APL.

19. A plasma display apparatus comprising;
a plasma display panel including a scan electrode and a sustain electrode that are positioned parallel to each other; and
a driver that displays an image on the plasma display panel in a frame including a plurality of subfields,
wherein the frame includes a plurality of subfield groups each including a plurality of subfields,
wherein the driver supplies a reset signal to the scan electrode during a reset period of at least one subfield of the plurality of subfields of the frame,
wherein the reset signal includes a rising period during which a rising signal with a gradually rising voltage is supplied, a falling period during which a falling signal with a gradually falling voltage is supplied, and a hold period between the rising period and the falling period, during which a maximum voltage of the falling signal is hold,
wherein when an average power level (APL) is a first level, a length of the hold period is a first length,
wherein when the APL is a second level higher than the first level, a length of the hold period is a second length different from the first length.

20. The plasma display apparatus of claim 19, wherein the second length is longer than the first length.
